(19) United States
(12) Patent Application Publication
(10) Pub. No.: US 2013/0305133 A1
(43) Pub. Date: Nov. 14, 2013

(54) Interactive Notepad For Computing Equations in Context

(71) Applicants: Elia Freedman, Portland, OR (US); Rick Huebner, Beaverton, OR (US)

(72) Inventors: Elia Freedman, Portland, OR (US); Rick Huebner, Beaverton, OR (US)

(21) Appl. No.: 13/469,426

(22) Filed: May 11, 2012

(51) Int. Cl. G06F 17/20

(52) U.S. Cl. 715/209

(57) ABSTRACT

A system, method and computer program product for interactive computing of equations in context includes parsing a user's notes, on an electronic computing device, for a delimited contextual mathematic equation relating a string variable of any number of blank spaces and characters to at least one other variable, a constant or a unit of measurement. Also assigning a numerical value to a variable, the numerical value determined by one of a computing, a user input and a context for the variable is included. Additionally, computing a numerically unassigned variable via the equation relating the variable(s), any constant(s) and any unit(s) of measurement is included. Declaring in the user's notes, on the electronic computing device, any computed and numerically unassigned variable(s) in context with the equation and any related variable(s) is further included. An interactive note computation may either be explicitly or implicitly initiated via a button or a contextual expression.

### BACKGROUND

Both calculators and spreadsheets are great at getting a result but neither really makes it easy to document what the results really mean or how to use the results for a particular application. Calculators and spreadsheets were designed for an era of text files and discrete computing. The spreadsheet had its genesis in an age where users shared data by moving files on a floppy disk. The electronic calculator had its start as a stand-alone tool and was later used as a DOS (disk operating system) window in a windows world. This approach of an earlier digital era is no longer sufficient nor competitive in today's digital world of seamless integration and portability to mobile phones and PDA (personal digital assistant) devices.

Even when spreadsheets are able to handle some math functions of interest, users may have to embed the spreadsheet into a text file if they want to be able to explain what variables mean and/or how an equation was derived. Many times an equation lacking annotation or a number without units is insufficient to help someone else make meaningful changes to an equation or interpret the results thereof. Knowing what a variable means, how a result was calculated or where an equation came from can therefore be just as important, if not more so, than the result and the equation themselves. This is especially true in areas of finance and engineering etc., but may also be true for customers and clients who want to know how a vendor or a serviceman arrived at a charge on their bill.

There has therefore been a long felt need for a seamless and integrated calculator in a text file environment that allows a user to annotate and explain an equation and actually perform the math functions therein. This long felt need extends into all areas of business, engineering and personal finance including but not limited to itemized billing, small business management, cut and paste engineering applications, mortgage payment estimators and taxable income accounting.

### SUMMARY OF THE INVENTION

A non-transitory computer readable medium having computer useable program code executable to perform operations for interactive computing as disclosed may include parsing a user's notes, on an electronic computing device, for at least one delimited contextual mathematic equation relating a string variable to at least one of another variable, a constant and a unit of measurement. The computer readable medium may also include program code executable to perform operations for assigning a numerical value to a variable, the numerical value determined by one of a computing, a user input and a context for the variable. The computer readable medium may additionally include program code executable to perform operations for computing a numerically unassigned variable via the equation relating the variable(s), any constant(s) and any unit(s) of measurement. The computer readable medium may further include program code executable to perform operations for declaring in the user's notes, on the electronic computing device, any computed and numerically unassigned variable(s) in context with the equation and any related variable(s).

An interactive computing notepad as disclosed may include a parsing module configured to parse a user's notes for at least one delimited contextual mathematic equation relating a string variable to at least one of another variable, a constant and a unit of measurement. The interactive computing notepad may also include an assigning module configured to assign a numerical value to a variable, the numerical value determined by one of a computing, a user input and a context for the variable. The interactive computing notepad may additionally include a computing module configured to compute a numerically unassigned variable via the equation relating the variable(s), any constant(s) and any units of measurement. The interactive computing notepad may further include a declaring module configured to declare by editing into the user's notes any computed and numerically unassigned variable(s) in context with the equation and any related variable(s).

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a flow chart of a method for interactive contextual computing with automatic variable assignment in accordance with an embodiment of the present disclosure.

FIG. 2 depicts a flow chart of a method for parsing a user's notes for one of an equation and a string variable comprising a mathematic operator, a mathematic word and a mathematic function in accordance with an embodiment of the present disclosure.

FIG. 3 depicts a flow chart of a method for computing a contextual equation via an iterative convergence and solving for one variable in terms of another variable in accordance with an embodiment of the present disclosure.

FIG. 4 depicts a flow chart of a method for initiating a computing of an equation and performing an ‘what if’ scenario analysis in accordance with an embodiment of the present disclosure.

FIG. 5 depicts a flow chart of a method for sharing user's equation templates in a database transfer and organizing a user's database for an electronic search of templates in accordance with an embodiment of the present disclosure.

FIG. 6 depicts a flow chart of a method for chaining equations together via string variables and a unit conversion using a hash delimiter in accordance with an embodiment of the present disclosure.

FIG. 7 depicts a computer screen comprising a contextual interactive template for a ‘Repair Proposal,’ in accordance with an embodiment of the present disclosure.

FIG. 8 depicts a computer screen comprising a contextual interactive template for a ‘Mortgage Payment,’ in accordance with an embodiment of the present disclosure.

FIG. 9 depicts a computer screen comprising a contextual interactive template for a ‘Grocery Purchase,’ in accordance with an embodiment of the present disclosure.

FIG. 10 depicts a computer screen comprising a database navigation bar comprising template names and a contextual interactive template in accordance with an embodiment of the present disclosure.

FIG. 11 depicts a flow chart of a method for delimiting a variable, an equation and ignoring, retaining and replacing an equation in accordance with an embodiment of the present disclosure.

FIG. 12 depicts a flow chart of a non-transitory computer program product for interactive contextual computing with automatic variable assignment in accordance with an embodiment of the present disclosure

FIG. 13 depicts the components of an interactive notepad for computing embedded equations in context in accordance with an embodiment of the present disclosure.

FIG. 14 depicts a wireless system for an interactive notepad for computing equations in context including a database server and notepad users in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Welcome to the interactive notepad for computing equations in context that actually knows how to do the math, perform calculations, write notes and intermix the two. A note may contain written text before, after or even in the middle of calculations and equations. Even variables may be documented. The disclosure allows any math function and computation from basic calculations to advanced calculus. All that may be required of a user is to enter an expression, followed by a delimiter such as an equals sign “=” or even the language term “equals,” in one of many languages and hit a calculate button ‘calc’ to perform the calculation. An embodiment of the disclosure may include an electronic display or screen that may be modified to provide access to an alphanumeric keyboard and often used math functions for mobile applications. Alternatively, a user may hit a ‘function’ button on the screen to access over 200 more functions including everything from powers and logs, programmer math (Boolean algebra on binary, hexadecimal and other number bases), complex numbers and matrices and more.

The term ‘delimiter’ as used throughout the present disclosure may refer to a sequence of one or more Unicode characters, words, phrases or symbols or any combination thereof used to specify a boundary between separate, independent mathematical regions in plain text and other data streams. The term ‘contextual’ may simply mean ‘with text’ and may refer to part of a text or statement that surrounds a particular equation or formula that may be used to determine the meaning of a variable, a result and therefore an equation itself. The term ‘method’ as used in the present disclosure may be implemented in a non-transitory computer readable medium having computer useable program code executable to perform operations for interactive computing. Therefore, the terms ‘method’ and ‘computer program product’ and the like may refer to the same or similar elements of the disclosure as claimed herein.

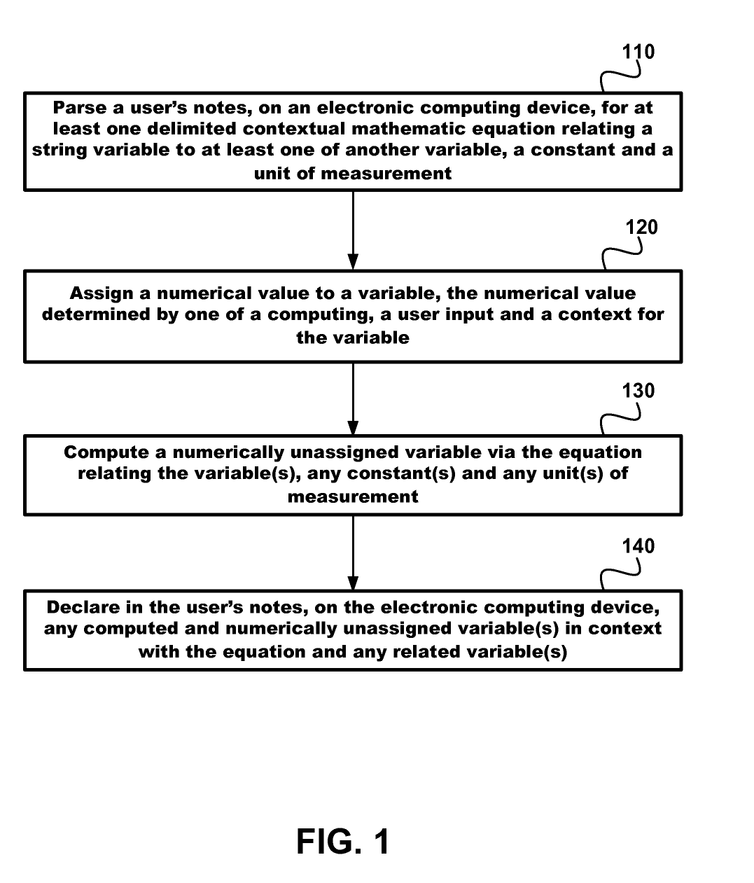

FIG. 1 depicts a flow chart of a method for interactive contextual computing with automatic variable assignment in accordance with an embodiment of the present disclosure. The disclosed method may include parsing 110 a user's notes, on an electronic computing device, for at least one delimited contextual mathematic equation relating a string variable to at least one of another variable, a constant and a unit of measurement. The disclosed method may also include assigning 120 a numerical value to a variable, the numerical value determined by one of a computing, a user input and a context for the variable. The disclosed method may additionally include computing 130 a numerically unassigned variable via the equation relating the variable(s), any constant(s) and any unit(s) of measurement. The disclosed method may further include declaring 140 in the user's notes, on the electronic computing device, any computed and numerically unassigned variable(s) in context with the equation and any related variable(s).

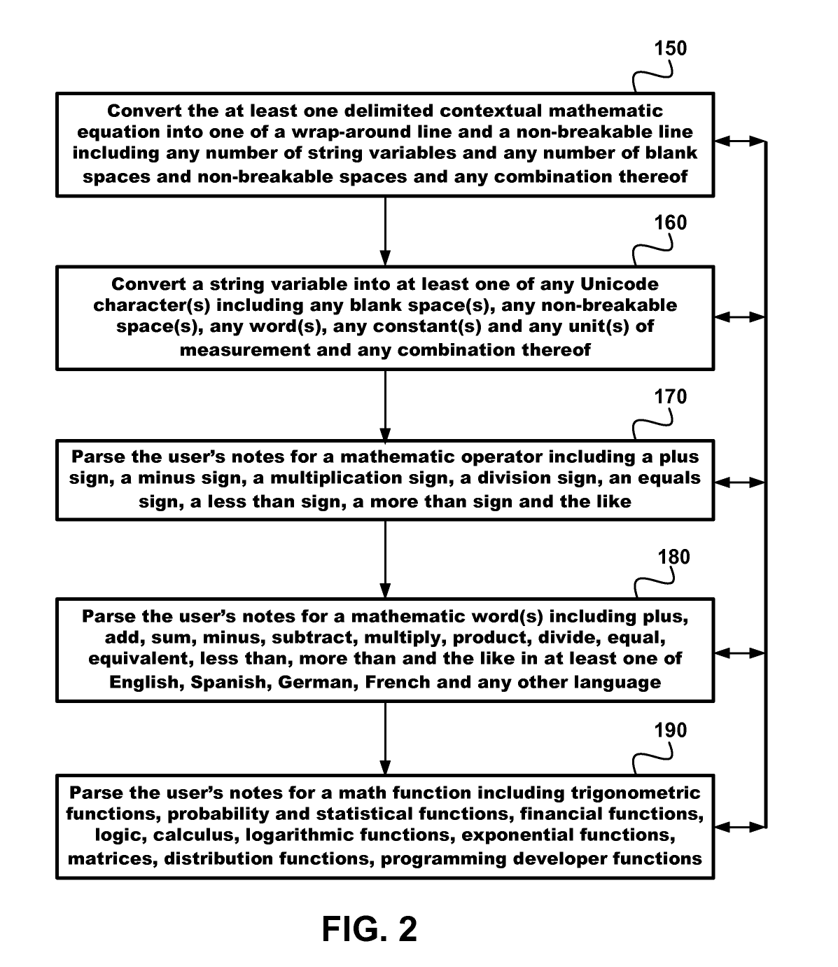

FIG. 2 depicts a flow chart of a method for parsing a user's notes for one of a delimited equation and a string variable comprising a mathematic operator, a mathematic word and a mathematic function in accordance with an embodiment of the present disclosure. The disclosure may find a delimited contextual equation and convert 150 the equation into one of a wrap-around line and a non-breakable line including any number of string variables and any number of spaces, non-breakable spaces and any combination thereof. The disclosure may also find a string variable and convert 160 it into at least one of any Unicode character(s) including any space(s), any non-breakable space(s), any word(s), any constant(s) and any unit(s) of measurement and any combination thereof.

Unicode is an international encoding standard for use with different languages and scripts, by which each letter, digit, or symbol may be assigned a unique numeric value that applies across different platforms and programs. Any Unicode character including but not limited to a space, a blank space, e.g. white space, may be included in a string variable of the present disclosure, but does not have to be included therein. The ASCII (American Standard Character) character set or the Unicode character set or any other set may be used therein. Unicode is a superset of the ASCII character set with provisions made for handling international symbols and characters from other languages and therefore facilitates the implementation of the disclosure in multiple languages. Unicode comprises sixteen bits and therefore takes up roughly twice the space as simple ASCII, but is correspondingly more flexible. This element of the present disclosure obviates the traditional programming requirement of ‘CamelCase’ (contiguous words having the first letter of each word capitalized) and underscore characters in a string variable.

In an embodiment of the present disclosure, equations may reside on their own text line. An equation or formula may automatically wrap to the next line but may not contain a return in the middle of the equation or formula (non-breakable line, NBL) unless an overriding “/# text #/ delimiter and the like is manually inserted by the note creator. The present disclosure may also include a non-breakable space (NBSP) in a string variable and/or in an equation. The NBSP also known as a non-breaking space or a no-brake space is a variant of the space character that prevents an automatic line break (line wrap) at its position. In certain formats (such as HTML), it may also prevent the “collapsing” of multiple consecutive whitespace characters into a single space. The non-breaking space is therefore also known as a hard space or fixed space. In Unicode, it is encoded at U+00A0. Text-processing software typically assumes that an automatic line break may be inserted anywhere a space character occurs; however, a non-breaking space prevents this from happening (provided the software recognizes the character). For example, if the text “100 miles” will not quite fit at the end of a line, some text editors may insert a line break between “100” and “miles”. To avoid this undesirable behavior, the present disclosure may choose to use a non-breaking space between “100” and “miles”. This guarantees that the text “100 miles” will not be broken.

Therefore in an embodiment of the present disclosure, the at least one delimited contextual mathematic equation may comprise one of a wrap-around line and a non-breakable line including any number of string variables and any number of non-breakable spaces and any combination thereof. In contrast to collapsible or breakable white space, non-breaking spaces may not merge with neighboring whitespace characters, and may therefore be used by a user to insert additional visible space in the formatted text.

Returning to FIG. 2, the disclosed method wherein parsing a user's notes, on an electronic computing device, for at least one delimited contextual mathematic equation may further comprise parsing 170 the user's notes for a mathematic operator including a plus sign ‘+’, a minus sign ‘−’, a multiplication sign ‘*’, a division sign ‘÷’, an equals sign ‘=’, a less than sign ‘<’, a more than sign ‘>’ and the like. The disclosed method may be implemented in a non-transitory computer readable medium for interactive computing. The disclosed method thus implemented may also include parsing 180 the user's notes for a mathematic word(s) including plus, add, sum, minus, subtract, multiply, product, divide, equal, equivalent, less than, more than and the like in at least one of English, Spanish, German, French and any other language. The disclosed method thus implemented may further include parsing 190 the user's notes for a mathematic function including a plurality of trigonometric functions, probability and statistical functions, financial functions, logic, calculus, logarithmic functions, exponential functions, matrices, distribution functions, programming developer functions (Boolean algebra on binary and hexadecimal, etc.) and any other mathematical function.

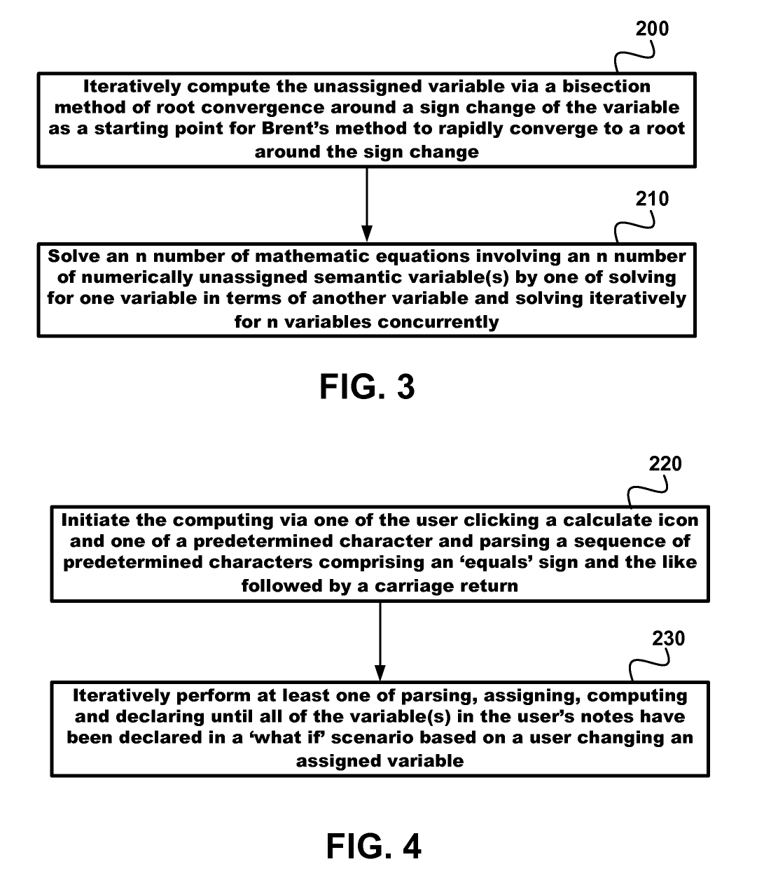

FIG. 3 depicts a flow chart of a method for computing a contextual equation via an iterative convergence and solving for one variable in terms of another variable in accordance with an embodiment of the present disclosure. The non-transitory computer readable medium for interactive computing, wherein computing a numerically unassigned variable via the equation may further comprise iteratively computing 200 the unassigned variable via a bisection method of root convergence around a sign change of the variable as a starting point for Brent's method to rapidly converge to a root around the sign change. The disclosed method and any elements thereof may be implemented in a non-transitory computer readable medium for interactive computing. The method thus implemented may further comprise solving 210 an n number of mathematic equations involving an n number of numerically unassigned string variable(s) by one of solving for one variable in terms of another variable and solving iteratively for n variables concurrently.

FIG. 4 depicts a flow chart of a method for initiating a computing of an equation and performing an ‘what if’ scenario analysis in accordance with an embodiment of the present disclosure. The disclosed method may further comprise initiating the computing 220 via one of the user clicking a calculate icon or a predetermined character. The computing may also be initiated 220 via parsing a sequence of predetermined characters comprising an ‘equals’ sign followed by a carriage return and the like for automatically detecting an inferential initiation of the computing. The disclosure may assume the note creator intended for a computing or calculating when a certain work such as ‘equals,’ ‘resulting in,’ etc. are typed into a note by the note creator or use. An embodiment of the disclosure therefore does not require the user to expressly hit a calculate icon to get a result. The disclosure may also infer the user intended the result by the context of his note. The disclosed method implemented in a non-transitory computer readable medium for interactive computing, may further comprise iteratively performing 230 at least one of parsing, assigning, computing and declaring until all of the variable(s) in the user's notes have been declared in a ‘what if’ scenario based on a user changing an assigned variable. The disclosed method, computer program product, device and system makes it very easy to do the same ‘what if’ analysis traditionally done in a spreadsheet except in an interface specifically designed for mobile devices and for the web.

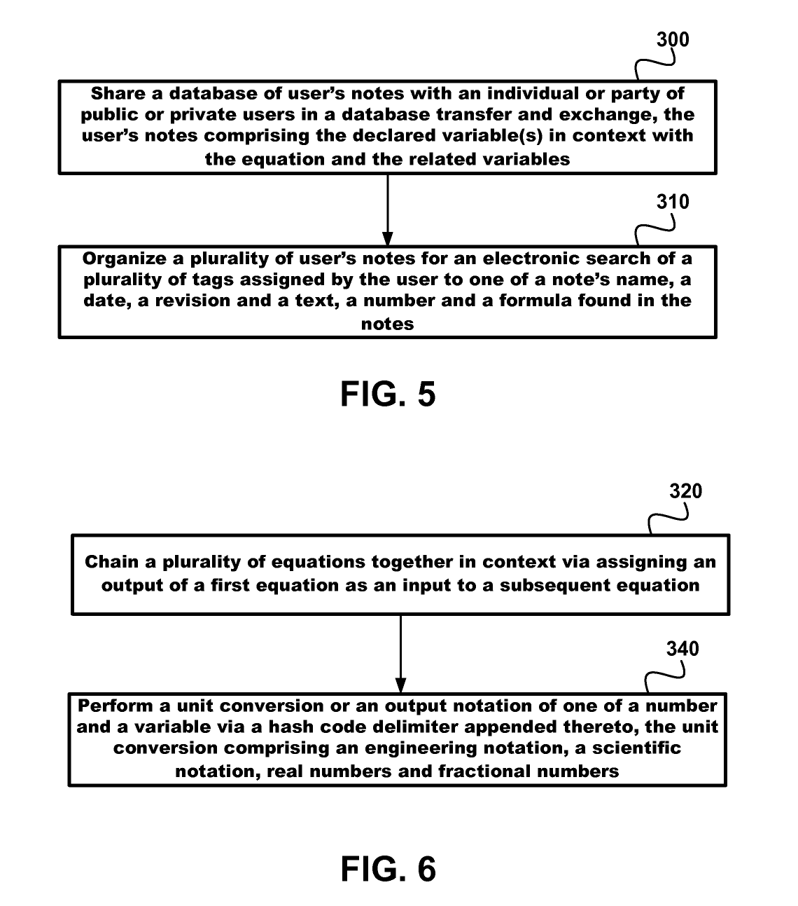

FIG. 5 depicts a flow chart of a method for sharing user's equation templates in a database transfer and organizing a user's database for an electronic search of templates in accordance with an embodiment of the present disclosure. The disclosed method may be realized via a non-transitory computer readable medium for interactive computing. Thus implemented, the method may further include sharing 300 a database of user's notes with one of an individual and a plurality of private and public users in a database transfer and exchange, the user's notes comprising the declared variable(s) in context with the equation and the related variables. The disclosed non-transitory computer readable medium for interactive computing, may further comprise organizing 310 a plurality of user's notes for an electronic search of a plurality of tags assigned by the user to one of a note's name, a date, a revision and a text, a number and a formula found in the notes.

For instance, how many people have heard of the Pythagorean Theorem but yet have no clue how to apply it in a practical setting. Someone who has applied the Pythagorean Theorem in purchasing a ladder for a certain roof height may want to share his application insight with others (a ladder leans against a house and forms a hypotenuse with the height of the roof). It may not be enough simply to share the equation H²=a²+b² to know what ladder height to buy but sharing how to apply the roof height and how far away from the house one leans a ladder, allows another to get a meaningful result and make an intelligent purchase. Sharing an application may allow others to avoid mistakes and rework and find the best known methods for any certain application of a formula or an equation. The ability to search on a tag or a key word in interactive contextual computing as disclosed, allows user's not only to better organize their own notes but also allows others to take advantage of practical applications discovered by others.

FIG. 6 depicts a flow chart of a method for chaining equations together via string variables and a unit conversion using a hash delimiter in accordance with an embodiment of the present disclosure. The disclosed method and any part or element thereof may be implemented in a non-transitory computer readable medium for interactive computing. Thus implemented, the method may further include chaining 320 a plurality of equations together in context via assigning an output of a first equation as an input to a subsequent equation. The disclosed method thus implemented in a non-transitory computer readable medium for interactive computing may also include performing 340 a unit conversion or an output notation for one of a number and a variable via a hash code delimiter and the like appended thereto. A unit conversion takes a number having a unit of measurement in feet, pounds, etc. and converts the number into units of meters, grams, etc. The unit conversion may comprise an engineering notation, a scientific notation, a real number and a fractional number etc. An output notation may be specified and changed via a hash code and other means. For instance, instead of defining a value to display with two places by typing ‘Var#2, the note creator or user may select the equals sign, “=” for variable ‘Var’ and choose the setting from a properties page. The equals sign and/or the language equivalent thereof, may serve multiple functions with different selections, including dragging values to an equals sign to assign them, setting properties, creating equations or variables automatically and calculating the desired variable, etc. In an embodiment of the disclosure, a plurality of settings which affect computing throughout an entire user's notes may be included. Such settings may be changed via one of a predetermined character and a sequence of predetermined characters in the user's notes or settings may be changed via the user clicking a settings icon or button.

An interactive contextual note as disclosed may include trigonometric functions and another may include length conversions. Interactive contextual templates are easy to set up per the disclosure. Embodiments of the disclosed method and computer program product may be used to perform a trigonometric calculation, e.g. to compute the cosine of 35. A user may enter the text ‘cosine 35=” and hit the ‘calc’ key to get a result. Calculation is only the tip of the iceberg though in the possible applications for the disclosure. When user's start combining computation with data and information they have typed about their notes, the disclosure gets a lot more powerful. For instance, an independent contractor wanting to give a quote to a client for doing repairs may easily enter a note with all the information about their client, all searchable later, organized into categories or tags to help them find it later. The contractor may even do the math on the work he or she has done for a client and print it out as an itemized bill with no modification or extra work required for the arithmetic in context.

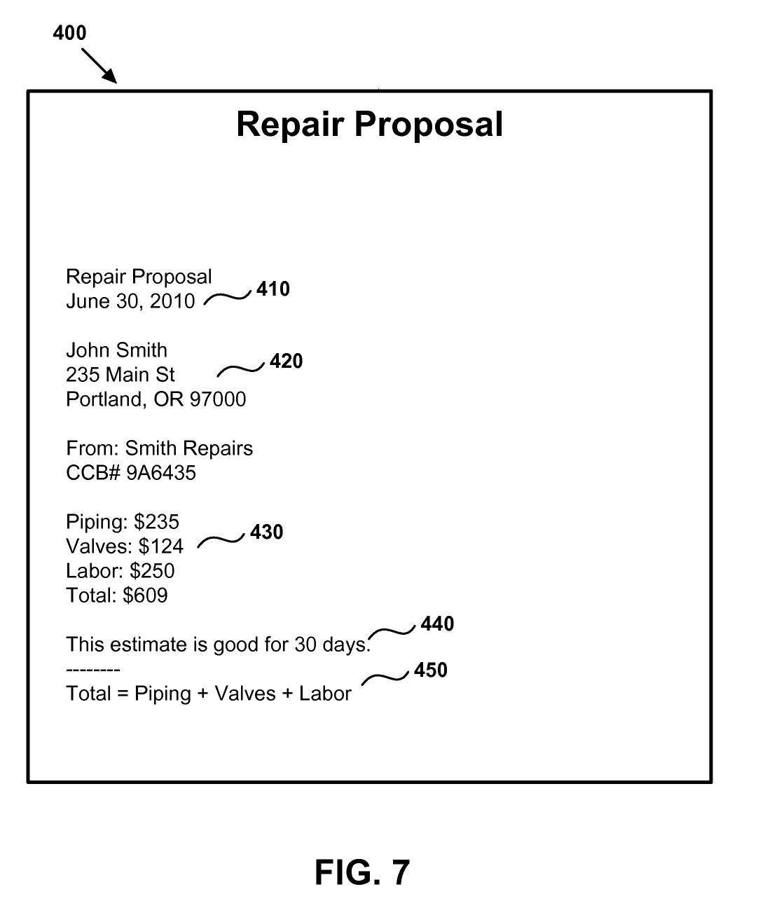

FIG. 7 depicts a computer screen comprising a contextual interactive template for a ‘Repair Proposal,’ in accordance with an embodiment of the present disclosure. The contextual note ‘Repair Proposal’ 400 may include the text 410 comprising tagged or searchable information such as a proposal or bid date and contractor or client identifying information. The contextual note 400 may also include the text 420 including an address for the independent contractor or for the client. The contextual note 400 may further include the text 430 comprising assigned and unassigned variables to be included in a formula or equation on the same page. Two hundred and thirty five dollars' worth of piping, valves and labor gives the total amount with information surrounding it to explain how the dollar amount was calculated for the sake of both the contractor and for the client. The text 440 may be contiguous with the variables 430 and include any note important to the contractor and/or client. The text 450 may comprise the equation using the above variables 430 used to automatically arrive at the result, ‘Total: $609.” The user's formula is included at the bottom of the page, away from the client's eyes but automatically able to do all the math needed in the proposal 400 and yet be apparent and immediately accessible to the user.

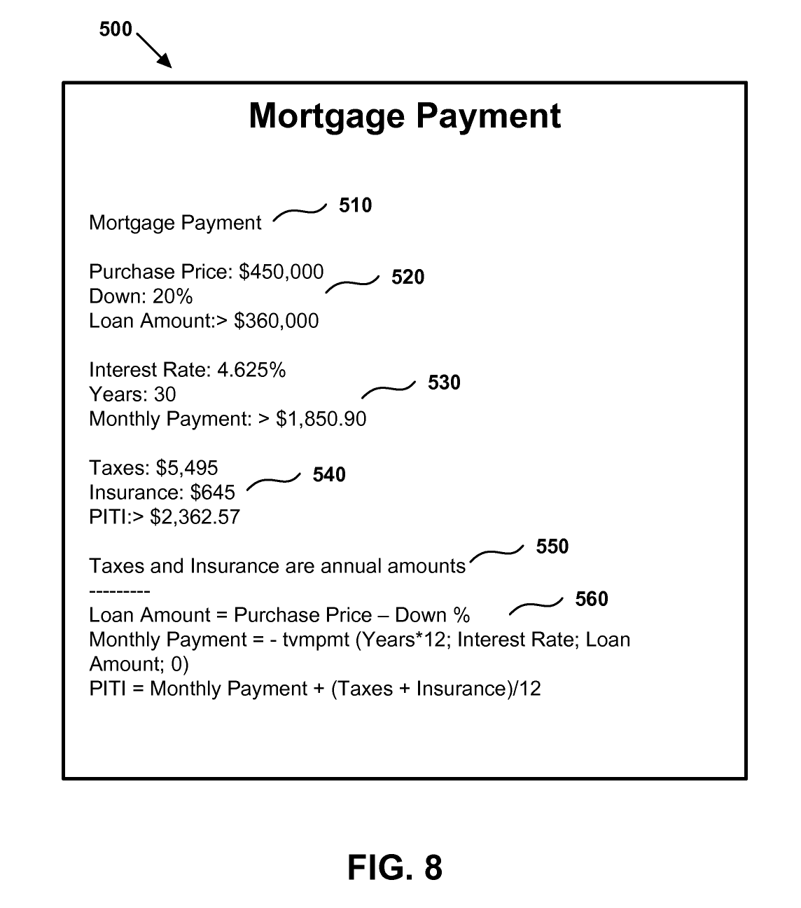

FIG. 8 depicts a computer screen comprising a contextual interactive template for a ‘Mortgage Payment,’ in accordance with an embodiment of the present disclosure. There are many different ways of setting up a notepad template per the present disclosure. For instance, an interactive and contextual note 500 for a mortgage payment may be calculated for a $450 thousand dollar property as shown by the assigned variables 510. The monthly payment may be calculated from the assigned variables 520 and the PITI (principal, interest, taxes and insurance) may be calculated from the assigned variables 530. If a user wanted to calculate the mortgage payment for a $500 thousand dollar property, he or she would erase the 450 and enter 500 in its place and hit the ‘calc’ button to get a new payment result. The text 540 may be contiguous with the variables 530 and include any note important to the user. The text 550 are three chained equations using the above variables 510, 520 and 530 used to arrive at the respective results Loan Amount, Monthly Payment and PITI. The user's formula is nicely included at the bottom of the page but may be included anywhere in the note.

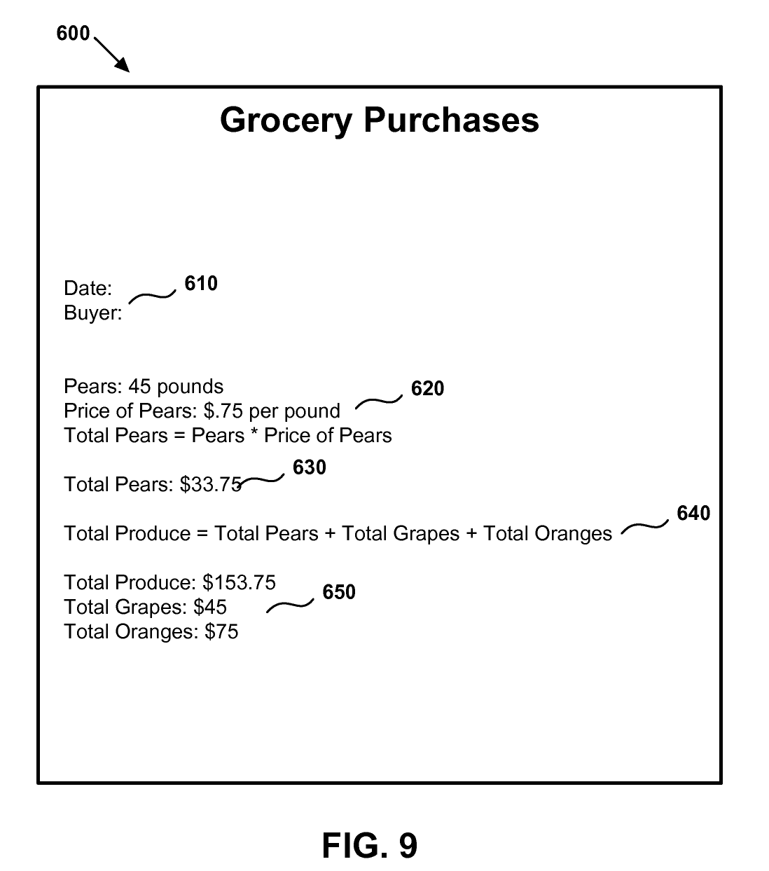

FIG. 9 depicts a computer screen comprising a contextual interactive template for a ‘Grocery Purchase,’ in accordance with an embodiment of the present disclosure. The contextual note ‘Grocery Purchase’ 600 may include the text 610 including a tagged or searchable data and other indicia. For instance, suppose a user of the disclosure worked in a grocery store and is in charge of the produce department. Today he is buying pears. He may need to know how many pears he can buy. If he has not already created an interactive contextual template to answer this question, he may search a common database of templates to find one or he may create one and start with what he does know. He may know that he wants to order 45 pounds of pears and enter that information as shown in the text 620. He may also know that the current price of pears is 75 cents a pound also entered in text 620. What is his formula for calculating how many pears he can buy? He may simply multiply the total weight of the pears by the price of pears.

The user of the disclosure declared the values for Pears and Price per Pound in the text 620 and assigned values of 45 and 0.75 to them, respectively. The disclosure didn't find Total Pears so declared it and because it was blank and all the other variables were known, it also calculated it. Alternatively, the user could have declared all the variables himself, including Total Pears. When he calculates via the disclosure, he automatically gets the result 630 shown as $33.75. He may also include the purchase of other produce via similar formulae. In an embodiment of the disclosure, these formulae know how to work together in context in the same interactive notepad template.

For instance, pears aren't the only thing the produce manager is buying today. He is going to also buy some grapes and some oranges. Since he has already setup the basic formula is in advance, he may hit calculate and the disclosure will automatically set up his variables 650 for him. He may put in currency symbols if he would like ($) and the symbols may be treated as a string variable with the numbers he assigns to a variables by the disclosure. He is going to buy $45 dollars' worth of grapes and $75 dollars' worth of oranges. He may then want to know much produce he can afford so he hits the ‘calc’ button and the total produce price appears. On the other hand, if instead he has a budget on any certain day for his produce department he can calculate how many of each product he may purchase. Today, he has $200 for produce and may therefore buy more grapes. He needs to therefore know how many grapes can he purchase so he erases his prior grapes number and enters $200 in Total Produce variable and hits ‘calc.’ The total grapes number automatically reappears and he has not only an answer but a document detailing how he arrived at that particular number that he can save in his database and refer to at any later point in time.

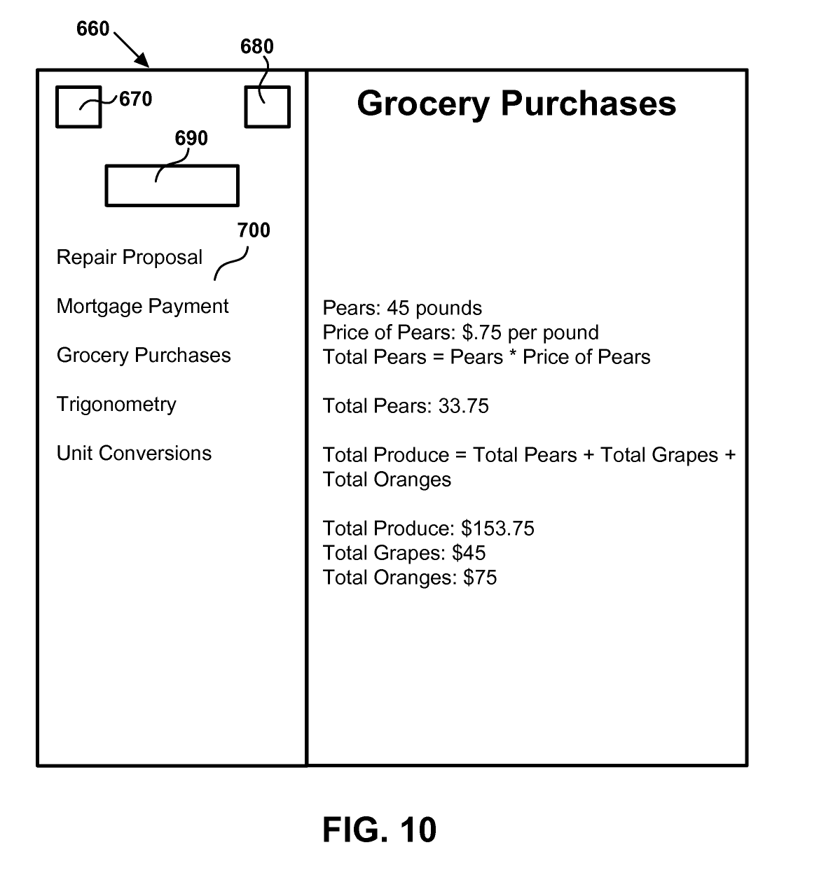

FIG. 10 depicts a computer screen comprising a database navigation bar comprising a directory of contextual note templates and a contextual interactive template in accordance with an embodiment of the present disclosure. The depiction includes a database navigation bar 660, an edit button 670, a virtual keyboard toggle button 680, a search term field 690 and a directory of notepad templates 700. The present directory includes Repair Proposal, Mortgage Payment, Grocery Purchases, Trigonometry and Unit of Measurement Conversions but may include any database file name(s) and folder(s) chosen by a user of the disclosure. In an embodiment of the present disclosure, the database navigation bar 660 may also comprise additional and various fields and virtual buttons to facilitate ease of use and navigability of the disclosure. It is noted that the equation “Total Produce=Total Pears+Total Grapes+Total Oranges” includes a line wrap after ‘Total Grapes+’ but does not include a line break and is therefore a non-breakable line (NBL). Additionally, the variable ‘Price of Pears’ for instance, does not include a line break but each space between the words ‘Price of Pears’ is a non-breakable space (NBSP).

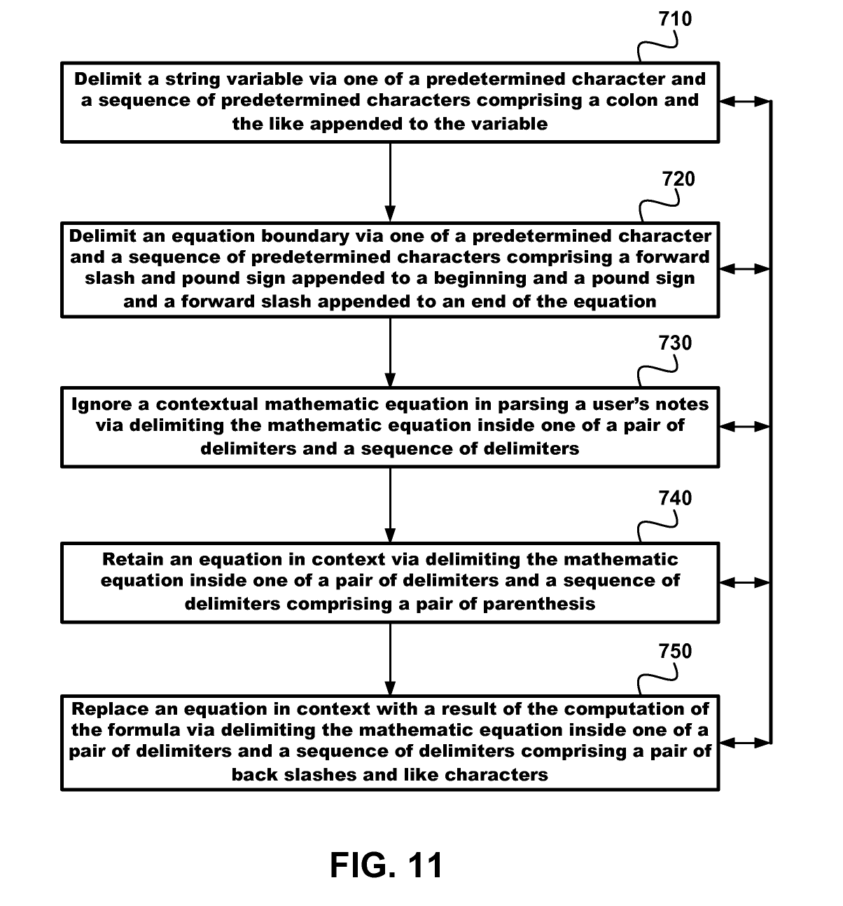

FIG. 11 depicts a flow chart of a method for delimiting a variable, an equation and ignoring, retaining and replacing an equation in accordance with an embodiment of the present disclosure. The method implemented in a non-transitory computer readable medium for interactive computing, comprises overriding a wrap-around line and a non-breakable line by delimiting 710 a string variable via one of a predetermined character and a sequence of predetermined characters comprising at least one of a colon and an equals sign “=” and the like appended to the variable. The method thus implemented also includes delimiting 720 an equation boundary via one of a predetermined character and a sequence of predetermined characters comprising a forward slash and pound sign appended to a beginning and a pound sign and a forward slash appended to an end of the equation. The disclosed method thus implemented in whole or in part additionally includes ignoring 730 a contextual mathematic equation in parsing a user's notes via delimiting the mathematic equation inside one of a pair of delimiters and a sequence of delimiters such as but not limited to a pair of forward slashes and the like. An equation may be ignored in an embodiment of the disclosure when a note creator wishes to make a comment (passive equation) rather than make a computation or calculation (active equation). The non-transitory computer readable medium for interactive for computing of the disclosed method further comprises retaining 740 an equation of at least one constant variable in context via delimiting the mathematic equation inside one of a pair of delimiters and a sequence of delimiters comprising a pair of parenthesis. When entering a variable's value, a user may know a value and sometimes may need to calculate it based on other known data. In the case where a note creator may want to retain the equation (as opposed to replacing the equation with a result), an embodiment of the disclosure offers retention notation. This notation may be used as the value of a variable:

### Total Payroll=Pay+FICA+Medical

### Total Payroll:>$

### Pay: (10,000+6,000+5,000)

### FICA: (Pay*11%)

### Medical: $1500

Internally, the disclosure may sum ‘Pay’ first then use that to calculate FICA (social security and Medicare contributions). However, because the parentheses notation was used, those computed values are not displayed but the equation ‘Pay*11%’ may be retained. However, since no parentheses were used for the ‘Total Payroll,’ the correct result for Total Payroll, $24,810 may be displayed. Note that in this case % is a math symbol used in the equation. One additional note: As demonstrated above, a user may use a variable to calculate another variable when utilizing replacement notation.

Again from FIG. 11, the implemented method may yet include replacing 750 an equation in context with a result of the computation of the formula via delimiting the mathematic equation inside one of a pair of delimiters and a sequence of delimiters comprising a pair of back slashes. For instance the following will calculate 360, replacing the slants and expression with the result: \30*12\. This notation can be used in the middle of a text description or as the value of a variable:

### Total Payroll=Pay+FICA+Medical

### Total Payroll:>$

### Pay: \10,000+6,000+5,000\

### FICA: \Pay*11%\

### Medical: $1500

An embodiment of the disclosure may sum ‘Pay’ first then use that to calculate FICA (social security and Medicare contributions). Because the back slant notation was used, 21,000 may replace \10,000+6,000+5,000\ and 2,310 may replace \Pay*11%\. Subsequently, the disclosure may calculate ‘Total Payroll.’ Note that in this case % is a math symbol used in the equation.

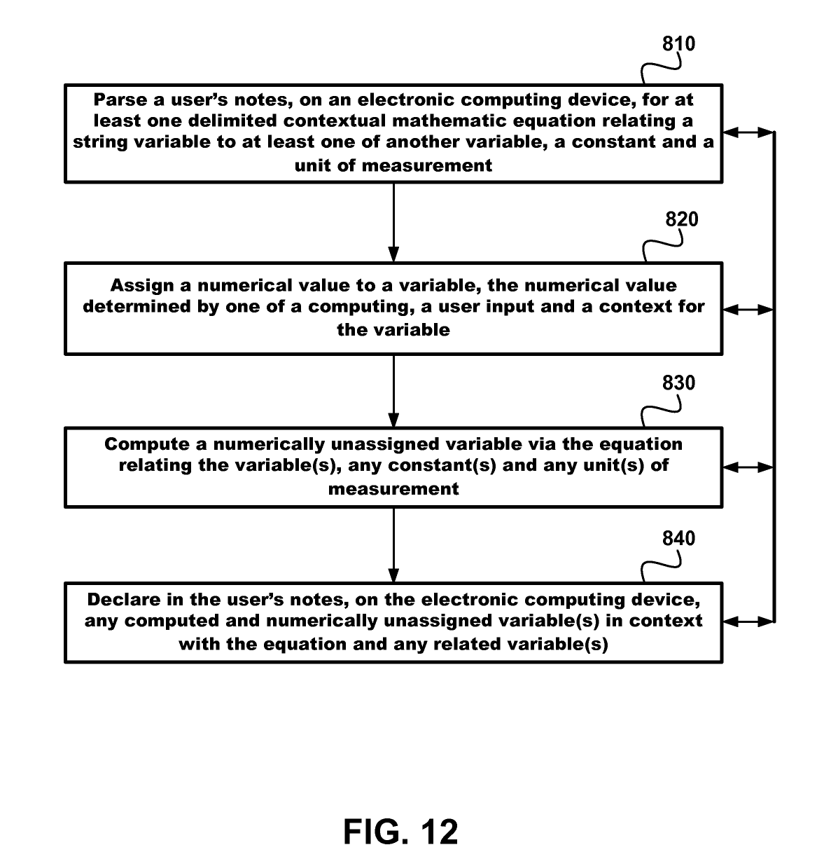

FIG. 12 depicts a flow chart of a non-transitory computer program product for interactive contextual computing with automatic variable assignment in accordance with an embodiment of the present disclosure. The non-transitory computer readable medium having computer useable program code executable to perform operations for interactive computing as disclosed may include parsing 810 a user's notes, on an electronic computing device, for at least one delimited contextual mathematic equation relating a string variable to at least one of another variable, a constant and a unit of measurement. The computer readable medium may also include program code executable to perform operations for assigning 820 a numerical value to a variable, the numerical value determined by one of a computing, a user input and a context for the variable. The computer readable medium may additionally include program code executable to perform operations for computing 830 a numerically unassigned variable via the equation relating the variable(s), any constant(s) and any unit(s) of measurement. The computer readable medium may further include program code executable to perform operations for declaring 840 in the user's notes, on the electronic computing device, any computed and numerically unassigned variable(s) in context with the equation and any related variable(s). The elements of the computer program code may be carried out in sequential or random order as depicted by arrow terminated lines.

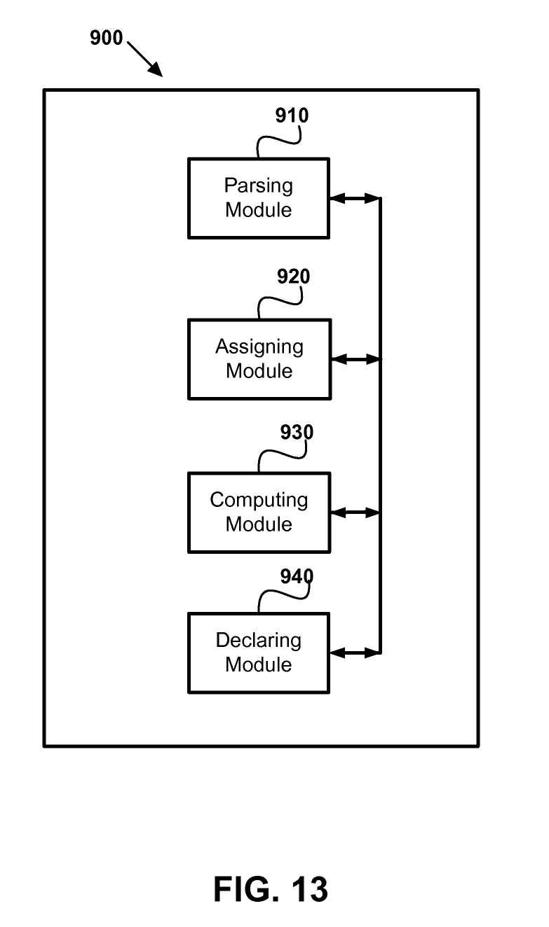

FIG. 13 depicts the components of an interactive notepad for computing equations in context in accordance with an embodiment of the present disclosure. An interactive computing notepad 900 as disclosed may include a parsing module 910 configured to parse a user's notes for at least one delimited contextual mathematic equation relating a string variable to at least one of another variable, a constant and a unit of measurement. The interactive computing notepad may also include an assigning module 920 configured to assign a numerical value to a variable, the numerical value determined by one of a computing, a user input and a context for the variable. The interactive computing notepad may additionally include a computing module 930 configured to compute a numerically unassigned variable via the equation relating the variable(s), any constant(s) and any unit(s) of measurement. The interactive computing notepad may further include a declaring module 940 configured to declare by editing into the user's notes any computed and numerically unassigned variable(s) in context with the equation and any related variable(s).

An embodiment of the present disclosure may include a standalone device comprising the computer program product and the methods discussed herein. Another embodiment of the disclosure may include a non-transitory application of the computer program product and the methods disclosed herein. Also, any combination of various standalone products and applications, either wireless or wired, may be included in embodiments of the present disclosure. Therefore, a keyboard and other input/output may be implemented in hardware and/or on an electronic display screen in multiple embodiments of the disclosure. Calculations and computations may also be performed directly in hardware and/or simulated in any application layer residing on the standalone device and/or the system as disclosed.

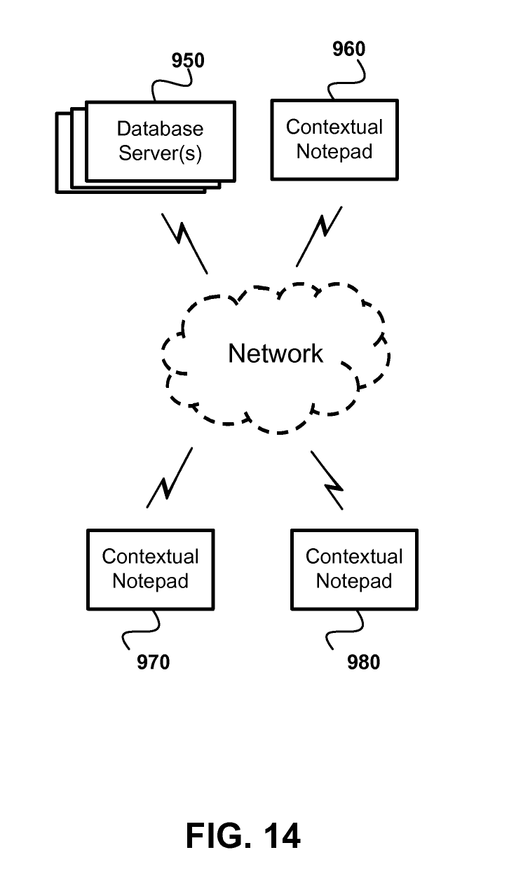

FIG. 14 depicts a wireless system for an interactive notepad for computing equations in context including a database server and notepad users in accordance with an embodiment of the present disclosure. The system depicted includes at least one database server(s) 950, a plurality of interactive contextual notepads 900 called out as 960, 970 and 980 and a wireless network there between including the internet and wireless connections thereto. The system depicted allows any user of the present disclosure, to share interactive contextual templates as discussed herein with other users. Peer to peer sharing of files and a database residing on any number of servers accessible to all users through the wireless network may also be comprised in an embodiment of the disclosure. Notes created with the disclosure may be shared individually or in a private or public grouping via a folder type arrangement.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A non-transitory computer readable medium having computer useable program code executable to perform operations for interactive computing, the operations of the computer readable medium comprising:
a) parsing a user's notes, on an electronic computing device, for at least one delimited contextual mathematic equation relating a string variable to at least one of another variable, a constant and a unit of measurement, the string variable comprising any Unicode character including a space, a non-breakable space and a plurality of any Unicode characters;
b) assigning a numerical value and a unit of measurement to a variable, the assigning determined by a context for the variable in the equation and one of a user input and a computing;
c) computing a numerically unassigned variable via the equation relating the variable(s), any constant(s) and a unit of measurement for the variable in context with the equation; and
d) declaring in the user's notes, on the electronic computing device, any computed and numerically unassigned variable(s) together with a respective unit of measurement in context with the equation and any related variable(s).

2. The non-transitory computer readable medium for interactive computing of claim 1, further comprising converting the at least one delimited contextual mathematic equation into one of a wrap-around line and a non-breakable line including any number of string variables and any number of spaces and any number of non-breakable spaces and any combination thereof.

3. The non-transitory computer readable medium for interactive computing of claim 2, further comprising overriding a wrap-around line and a non-breakable line by delimiting an equation boundary via one of a predetermined character and a sequence of predetermined characters comprising a forward slash and pound sign appended to a beginning and a pound sign and a forward slash appended to an end of the equation.

4. The non-transitory computer readable medium for interactive computing of claim 1, further comprising converting a string variable into at least one of any Unicode character including a space, a non-breakable space, a word, a constant and a unit of measurement and a plurality of any Unicode characters including any plurality of spaces, any plurality of non-breakable spaces, any plurality of words, any plurality of constants and any plurality of units of measurement and any combination thereof.

5. The non-transitory computer readable medium for interactive computing of claim 1, wherein a) parsing a user's notes, on an electronic computing device, for at least one delimited contextual mathematic equation comprises parsing the user's notes for a mathematic operator including a plus sign, a minus sign, a multiplication sign, a division sign, an equals sign, a less than sign, a more than sign and any mathematic operator.

6. The non-transitory computer readable medium for interactive computing of claim 1, wherein a) parsing a user's notes, on an electronic computing device, for at least one delimited contextual mathematic equation comprises parsing the user's notes for a mathematic word(s) including plus, add, sum, minus, subtract, multiply, product, divide, equal, equivalent, less than, and more than in at least one of Spanish, German, French and any language other than English.

7. The non-transitory computer readable medium for interactive computing of claim 1, wherein a) parsing a user's notes, on an electronic computing device, for at least one delimited contextual mathematic equation comprises parsing the user's notes for a mathematic function including a plurality of trigonometric functions, probability and statistical functions, financial functions, logic, calculus, logarithmic functions, exponential functions, matrices, distribution functions, programming developer functions and any other mathematical function.

8. The non-transitory computer readable medium for interactive computing of claim 1, wherein c) computing a numerically unassigned variable via the equation comprises iteratively computing the unassigned variable via a bisection method of root convergence around a sign change of the variable as a starting point for Brent's method to rapidly converge to a root around the sign change.

9. The non-transitory computer readable medium for interactive computing of claim 1, wherein c) computing a numerically unassigned variable comprises initiating the computing via one of the user clicking a calculate icon and one of another predetermined character and parsing a sequence of predetermined characters comprising an ‘equals’ sign followed by any character including a carriage return for automatically detecting an inferential initiation of the computing.

10. The non-transitory computer readable medium for interactive computing of claim 1, further comprising iteratively performing at least one of parsing, assigning, computing and declaring until all of the variable(s) in the user's notes have been declared in a ‘what if’ scenario based on a user input for an equation result and a user changing an assigned variable in the equation.

11. The non-transitory computer readable medium for interactive computing of claim 1, further comprising sharing a database of user's notes with one of an individual and a plurality of private and public users in a database transfer and exchange, the user's notes comprising an application of the declared variable(s) in context with the equation and the related variables to a specific problem in a practical setting.

12. The non-transitory computer readable medium for interactive computing of claim 1, further comprising organizing a plurality of user's notes for an electronic search of a plurality of tags assigned by the user to one of a note's name, a date, a revision and a text, a number and a formula found in the notes.

13. The non-transitory computer readable medium for interactive computing of claim 1, further comprising chaining a plurality of equations together in context via assigning an output of a first equation as an input to a subsequent equation.

14. The non-transitory computer readable medium for interactive computing of claim 1, further comprising delimiting a string variable via one of a predetermined character and a sequence of predetermined characters comprising at least one of a colon, and an equals sign “=” and any character appended to the variable.

15. The non-transitory computer readable medium for interactive computing of claim 1, further comprising ignoring a contextual mathematic equation in parsing a user's notes via delimiting the mathematic equation inside one of a pair of delimiters and a sequence of delimiters including but not limited to a pair of forward slashes and any delimiter and any sequence of delimiters.

16. The non-transitory computer readable medium for interactive for computing of claim 1, further comprising retaining an equation of at least one constant variable in context via delimiting the mathematic equation inside one of a pair of delimiters and a sequence of delimiters comprising a pair of parentheses and any delimiter and any sequence of delimiters.

17. The non-transitory computer readable medium for interactive computing of claim 1, further comprising replacing an equation in context with a result of the computation via delimiting the mathematic equation inside one of a pair of delimiters and a sequence of delimiters comprising a pair of back slashes and any delimiter and any sequence of delimiters.

18. The non-transitory computer readable medium for interactive computing of claim 1, further comprising performing one of a unit conversion and an output notation for at least one of a number and a variable via a hash code delimiter and any delimiter appended thereto, the unit conversion and output notation comprising an engineering notation, a scientific notation, a real number and a fractional number.

19. An interactive notepad computer having non-transitory and constituent functional components, comprising:
a) a parsing component of the computer configured to parse a user's notes for at least one delimited contextual mathematic equation relating a string variable to at least one of another variable, a constant and a unit of measurement, the string variable comprising any Unicode character including a space, a non-breakable space and a plurality of any Unicode characters;
b) an assigning component of the computer configured to assign a numerical value and a unit of measurement to a variable, the assigning determined by a context for the variable in the equation and one of a user input and a computing;
c) a computing component of the computer configured to compute a numerically unassigned variable via the equation relating the variable(s), any constant(s) and a unit of measurement for the variable in context with the equation; and
d) a declaring component of the computer configured to declare by editing into the user's notes any computed and numerically unassigned variable(s) together with a respective unit of measurement in context with the equation and any related variable(s).

20. A method for interactively computing variables in context with user input, comprising:
a) parsing a user's notes, on an electronic computing device, for at least one delimited contextual mathematic equation relating a string variable to at least one of another variable, a constant and a unit of measurement, the string variable comprising any Unicode character including a space, a non-breakable space and a plurality of any Unicode characters;
b) assigning a numerical value and a unit of measurement to a variable, the assigning determined by a context for the variable in the equation and one of a user input and a computing;
c) computing a numerically unassigned variable via the equation relating the variable(s), any constant(s) and a unit of measurement for the variable in context with the equation; and
d) editing in the user's notes, on the electronic computing device, any computed and numerically unassigned variable(s) together with a respective unit of measurement in context with the equation and any related variable(s).
